(19) United States
(12) Patent Application Publication
(10) Pub. No.: US 2012/0325590 A1
(43) Pub. Date: Dec. 27, 2012

(54) ELEVATOR

(75) Inventors: Petteri VALJUS, Helsinki (FI); Raimo PELTO-HUIKKO, Vantaa (FI)

(73) Assignee: KONE CORPORATION, Helsinki (FI)

(21) Appl. No.: 13/606,943

(22) Filed: Sep. 7, 2012

Related U.S. Application Data
(63) Continuation of application No. PCT/FI2011/000020, filed on Apr. 12, 2011.

(30) Foreign Application Priority Data
Apr. 12, 2010 (FI) 20100149

(51) Int. Cl. B66B 5/04; B66B 7/06

(52) U.S. Cl. 187/251

(57) ABSTRACT

Elevator, which comprises at least an elevator car and means for moving the elevator car, preferably along guide rails, and an overspeed governor arrangement, which comprises an overspeed governor rope, which moves according to the movement of the elevator car, and which overspeed governor rope is connected to a brake arrangement that is in connection with the elevator car such that with the overspeed governor rope force can be transmitted to the brake arrangement for shifting the brake comprised in the brake arrangement into a braking position. The rope comprises a power transmission part or a plurality of power transmission parts, for transmitting force in the longitudinal direction of the rope, which power transmission part is essentially fully of non-metallic material.

### CROSS REFERENCE TO RELATED APPLICATIONS

This application is a continuation of International Application Number PCT/FI2011/000020 filed Apr. 12, 2011 and claims priority to Finish Application Number 20100149 filed Apr. 12, 2010, the entire contents of each of which are hereby incorporated herein by reference.

### FIELD OF THE INVENTION

The object of the invention is an elevator, preferably an elevator applicable to moving people.

### BACKGROUND OF THE INVENTION

In the overspeed governor arrangements in prior-art elevators, the elevator is provided with a safety gear, the tripping of which occurs from the triggering of the overspeed governor. The conventional solution is that when the speed of the elevator increases to a limit value set in advance for the overspeed governor, the overspeed governor trips the safety gear via the same rope as the rope via which the overspeed governor monitors the speed of the elevator. Publication U.S. Pat. No. 4,653,612 describes the structure and operation of one such overspeed governor. Publications US2007/0181378A1 and F194948B present other overspeed governor solutions. In prior-art solutions ropes are conventionally round spiral ropes in their cross-section, the power transmission parts of which ropes are of metallic material. A problem in solutions according to prior-art is that the strength properties of metal in relation to its mass are such that the rope must be formed to be large in terms of its mass. When producing acceleration or deceleration in the elevator car, a corresponding change in speed must also be produced in the overspeed governor rope. The magnitude of the energy consumed for this depends on the mass of the rope. Yet another problem has been the creeping of metal ropes. Owing to creeping, the support of the weight tensioning the overspeed governor rope must from time to time be shifted for rectifying the tensioning margin.

### AIM OF THE INVENTION

The aim of the invention is to produce an elevator that has a better overspeed governor arrangement than before. The object of the invention is to eliminate, among others, the aforementioned drawbacks of prior-art solutions. The aim of the invention is further to produce one or more of the following advantages, among others:
An energy-efficient elevator is achieved.
A space-efficient elevator is achieved, the overspeed governor rope of which is light and small in terms of its bending radius.
An elevator is achieved, the mass of the parts of which that move along with the car is lower than before.
An elevator is achieved, the creeping of the overspeed governor rope of which is minor.
An elevator is achieved, the braking of the overspeed governor rope of which can be implemented with a large surface area simply and gently without damaging the fibers of the rope.
An elevator is achieved, wherein a larger proportion than before of the force acting on the rope is transmitted to the brake.
An elevator is achieved, wherein the traction needed for braking of the overspeed governor rope of which elevator is less than before.
An elevator is achieved, the lateral movement of the overspeed governor rope of which is minor.

### SUMMARY OF THE INVENTION

The invention is based on the concept that if the overspeed governor rope of an elevator is formed to be such that its longitudinal power transmission capability is based on non-metallic material, more particularly on non-metallic fibers, the rope can be lightened and as a result of the lightness the energy efficiency of the elevator can be improved. What is now invented is that although the overspeed governor rope forms a very small part of the moving masses of the elevator, by forming the rope in a specified way, considerable savings can be achieved even though inexpensive metal is replaced with a more expensive material.

In a basic embodiment of the concept according to the invention the elevator comprises at least an elevator car and means for moving the elevator car, preferably along guide rails, and an overspeed governor arrangement, which comprises an overspeed governor rope, which moves according to the movement of the elevator car, and which overspeed governor rope is connected to a brake arrangement that is in connection with the elevator car such that with the overspeed governor rope force can be transmitted to the brake arrangement for shifting the brake comprised in the brake arrangement into a braking position. The rope comprises a power transmission part or a plurality of power transmission parts, for transmitting force in the longitudinal direction of the rope, which power transmission part is essentially fully of non-metallic material. Thus an energy-efficient elevator is achieved, because the mass of the parts that move along with the movement of the car is lower than before. Thus also the force required for slowing down/stopping the rope is small, and the force needed to bring about the force is likewise small. Acting on the rope is thus simple, and e.g. achieving sufficient traction can be less problematic than before. Thus a larger proportion than before of the force acting on the rope is transmitted to the car to the brake arrangement. In this way also the other aforementioned advantages can be achieved.

In a more refined embodiment of the concept according to the invention the overspeed governor rope passes around at least one diverting pulley comprised in the overspeed governor arrangement, bending at the point of the diverting pulley around an axis that is in the width direction of the rope, and the width of the overspeed governor rope is greater than the thickness. One advantage, among others, is that the bending radius of the rope can be reduced without losing supporting cross-sectional area. As a consequence, the rope can be manufactured from rigid material, the elongation properties of which would otherwise prevent an advantageous bending radius. The use of a rigid material reduces creeping problems, e.g. dimension problems caused by creeping that is caused by tensioning of the rope. The rope can thus also be formed to comprise a larger surface area than before, via which the speed of the rope can be acted on, e.g. for braking the rope. In this way the rope can be acted on more reliably than before without damaging the non-metallic parts of the rope. More particularly, a large surface area enables rapid deceleration/stopping of the rope without slipping problems, e.g. in an overspeed situation.

In a more refined embodiment of the concept according to the invention essentially all the power transmission parts of the rope for transmitting force in the longitudinal direction of the rope are essentially fully of non-metallic material. In this way the whole longitudinal power transmission of the rope can be arranged with light material alone. The energy efficiency is thus significant.

In a more refined embodiment of the concept according to the invention each aforementioned power transmission part is of a material which comprises non-metallic fibers in essentially the longitudinal direction of the rope. In this way the whole longitudinal power transmission of the rope can be arranged to be light using light fibers. Longitudinal alignment increases the rigidity of the rope, owing to which creeping problems can be reduced. One advantage is also the avoidance of entwining of the rope. In particular a thin and light rope of the overspeed governor, which typically contains a relatively low tautness, could otherwise try to twist.

In a more refined embodiment of the concept according to the invention the aforementioned material is a composite material, which comprises non-metallic fibers as reinforcing fibers in a polymer matrix. In this way a light structure that is rigid in the longitudinal direction can be formed. For example, creeping caused by tensioning can be reduced. Increasing the length of the overspeed governor rope could cause a dangerous situation. For the reduction of creeping problems the tensioning can be implemented simply and a very frequent and repetitive need for additional tensioning is nevertheless avoided.

In a more refined embodiment of the concept according to the invention the aforementioned non-metallic fibers are carbon fibers or glass fibers. Owing to the heat resistance and lightness of these fibers, the elevator is fireproof but, however, energy-efficient.

In a more refined embodiment of the concept according to the invention the aforementioned non-metallic fibers are Aramid fibers. Thus the elevator is inexpensive, safe and energy-efficient.

In a more refined embodiment of the concept according to the invention the aforementioned power transmission part, or plurality of power transmission parts, covers majority, preferably 60% or over, more preferably 65% or over, more preferably 70% or over, more preferably 75% or over, most preferably 80% or over, most preferably 85% or over, of the width of the rope. In this way at least majority of the width of the rope will be effectively utilized and the rope can be formed to be light and thin in the bending direction for reducing the bending resistance.

In a more refined embodiment of the concept according to the invention the overspeed governor arrangement comprises means for acting on the movement of the overspeed governor rope, more particularly for slowing down and/or preventing movement, which means are preferably supported on the building.

In a more refined embodiment of the concept according to the invention the overspeed governor rope is connected to a brake arrangement that is in connection with the elevator car such that with the overspeed governor rope force can be transmitted from the means to the brake arrangement for acting on the movement of the overspeed governor rope for shifting the brake into a braking position. Thus the elevator is safe and the brake can be activated via the rope.

In a more refined embodiment of the concept according to the invention the means are arranged to exert a force on the overspeed governor rope, in the longitudinal direction of the rope, slowing down the overspeed governor rope or preventing its movement via at least one wide side of the rope, preferably by means of friction and/or shape-locking. The area of the action surface is thus large, so that the rope can be acted on gently.

In a more refined embodiment of the concept according to the invention the means comprise a brake part, which can be shifted into contact with the wide side of the rope for slowing down the overspeed governor rope or for preventing its movement. Thus the brake part is simple to activate and the arrangement can be simply used e.g. as an anticreep device.

In a more refined embodiment of the concept according to the invention the means comprise a brake part and a brake part that are on opposite sides of the overspeed governor rope, which brake parts form a gripper, which can be shifted into a position compressing the overspeed governor rope for slowing down and/or preventing movement of the overspeed governor rope. Thus the structure is effective and safe. More particularly, a gripper acting on the side surfaces of the width direction is able to act on the rope gently with a small compressive force, and to nevertheless achieve good traction owing to the large area.

In a more refined embodiment of the concept according to the invention the aforementioned plurality of power transmission parts is formed from a plurality (more particularly in the width direction of the rope) of parallel power transmission parts. In this way the bending radius of the rope can be further reduced. The width of the rope and therefore the surface area can thus be increased for increasing the action surface and for further facilitating acting on the rope. A large surface area enables fast gripping situations without slipping problems. Manufacturing is also simple without changing the power transmission parts, because ropes of different lengths and tensile strength requirements can be formed simply by selecting the most suitable amount of power transmission parts for each need.

In a more refined embodiment of the concept according to the invention the width/thickness of the rope is at least 2 or more, preferably at least 4, even more preferably at least 5 or more, yet even more preferably at least 6, yet even more preferably at least 7 or more, yet even more preferably at least 8 or more, most preferably of all more than 10. In this way good power transmission capability is achieved with a small bending radius. This can be implemented preferably with a composite material presented in this patent application, for which material a large width/thickness ratio is very important owing to its rigidity. A large surface area also enables rapid deceleration/stopping of the rope without slipping problems, e.g. in an overspeed situation.

In a more refined embodiment of the concept according to the invention the width of the rope is over 10 mm and the thickness of the aforementioned power transmission part at most 2 mm. In this way a very flexible thin rope that is very well suited to elevator use is achieved. A large surface area enables rapid deceleration/stopping of the rope without slipping problems, e.g. in an overspeed situation.

In a more refined embodiment of the concept according to the invention the aforementioned power transmission part must be suited to transmit force in the longitudinal direction of the rope from the point of the means to the brake arrangement via a power transmission part continuing from the point of the means up to the brake arrangement on the elevator car.

In a more refined embodiment of the concept according to the invention the aforementioned power transmission part or plurality of power transmission parts covers over 40% of the surface area of the cross-section of the rope, preferably 50% or over, even more preferably 60% or over, even more preferably 65% or over. In this way a large part of the cross-sectional area of the rope can be formed to be supporting. This can be implemented particularly well with the composite presented in this patent application.

In a more refined embodiment of the concept according to the invention the width of the aforementioned power transmission part is greater than the thickness, preferably such that the width/thickness of the aforementioned power transmission part is at least 2 or more, preferably at least 3 or more, even more preferably at least 4 or more, yet even more preferably at least 5, most preferably of all more than 5. In this way a wide rope can be formed simply and to be thin. A large surface area enables rapid deceleration/stopping of the rope without slipping problems, e.g. in an overspeed situation.

In a more refined embodiment of the concept according to the invention the aforementioned plurality of power transmission parts is formed from a plurality of parallel power transmission parts that are parallel in the width direction of the rope and are on at least essentially the same plane. In this way the behavior in bending is advantageous.

In a more refined embodiment of the concept according to the invention the brake is arranged to shift into a braking position as a result of relative movement of the rope and of the elevator car. Thus the arrangement is safe.

In a more refined embodiment of the concept according to the invention the aforementioned power transmission part or plurality of power transmission parts is surrounded with a coating, which is preferably of polyurethane. Thus power transmission to the rope or out of the rope is easy to execute by means of the part protecting the rope. The friction properties also enable rapid deceleration/stopping of the rope without slipping problems, e.g. in an overspeed situation of the elevator car.

In a more refined embodiment of the concept according to the invention the individual reinforcing fibers are evenly distributed into the aforementioned matrix. Thus the composite part of the power transmission part, which composite part is even in its material properties and has a long life, is effectively reinforced with fibers.

In a more refined embodiment of the concept according to the invention the aforementioned reinforcing fibers are continuous fibers in the longitudinal direction of the rope, which fibers preferably continue for essentially the distance of the whole length of the rope. The structure thus formed is rigid and easy to form.

In a more refined embodiment of the concept according to the invention the individual reinforcing fibers are bound together into a uniform power transmission part with the aforementioned polymer matrix, preferably in the manufacturing phase by embedding the reinforcing fibers into the material of the polymer matrix. Thus the structure of the power transmission part is uniform.

In a more refined embodiment of the concept according to the invention the structure of the rope continues essentially the same for the whole distance of the rope.

In a more refined embodiment of the concept according to the invention the fibers are essentially unentwined in relation to each other. In this way an advantage, among others, of the straight fibers longitudinal to the rope is the rigid behavior and small relative movement/internal wear of the power transmission part formed by them. The aforementioned creeping problems can thus be reduced. One advantage is also the avoidance of entwining of the rope. In particular a thin and light rope of the overspeed governor, which typically contains a relatively low tautness, could otherwise try to twist.

In a more refined embodiment of the concept according to the invention the structure of the power transmission part continues essentially the same for the whole length of the rope. One advantage is rigidity and the avoidance of entwining of the rope. In particular, a thin and light rope of the overspeed governor, which typically contains a relatively low tautness, could otherwise try to twist.

In a more refined embodiment of the concept according to the invention the polymer matrix is of a non-elastomer. Thus the matrix essentially supports the reinforcing fibers.

In a more refined embodiment of the concept according to the invention the module of elasticity of the polymer matrix is over 2 GPa, most preferably over 2.5 GPa, yet more preferably in the range 2.5-10 GPa, most preferably of all in the range 2.5-3.5 GPa. In this way a structure is achieved wherein the matrix essentially supports the reinforcing fibers. One advantage, among others, is a longer service life and also the enablement of smaller bending radiuses.

In a more refined embodiment of the concept according to the invention the polymer matrix comprises epoxy, polyester, phenolic plastic or vinyl ester. In this way a structure is achieved wherein the matrix essentially supports the reinforcing fibers. One advantage, among others, is a longer service life and the enablement of smaller bending radiuses.

In a more refined embodiment of the concept according to the invention over 50% of the surface area of the cross-section of the power transmission part is of the aforementioned reinforcing fiber, preferably such that 50%-80% is of the aforementioned reinforcing fiber, more preferably such that 55%-70% is of the aforementioned reinforcing fiber. Essentially all the remaining surface area is of polymer matrix. Most preferably such that approx. 60% of the surface area is of reinforcing fiber and approx. 40% is of matrix material. With this advantageous strength properties are achieved while at the same time the amount of matrix material is, however, sufficient to surround sufficiently the fibers it binds into one.

In a more refined embodiment of the concept according to the invention each aforementioned power transmission part is surrounded with a polymer layer, which is preferably of elastomer, most preferably of high-friction elastomer such as for instance polyurethane, which layer forms the surface of the rope. In this way power transmission to the rope is simple without damaging the rope. The friction properties enable rapid deceleration/stopping of the rope without slipping problems, e.g. in an overspeed situation of the elevator car.

In a more refined embodiment of the concept according to the invention the aforementioned power transmission part is a uniform elongated piece. A rigid part formed in this way returns by itself to its shape.

In a more refined embodiment of the concept according to the invention essentially all the reinforcing fibers of the aforementioned power transmission part are in the longitudinal direction of the rope.

In a more refined embodiment of the concept according to the invention the power transmission part is composed of the aforementioned polymer matrix, of reinforcing fibers bound to each other by the polymer matrix, and also possibly of a coating around the fibers, and also possibly of additives mixed into the polymer matrix.

In a more refined embodiment of the concept according to the invention with the overspeed governor rope force can be transmitted from the aforementioned means to the brake via the aforementioned diverting pulley, e.g. by slowing down and/or preventing the movement of the diverting pulley.

In a more refined embodiment of the concept according to the invention the rope does not comprise such a quantity of metal wires that together they would form an essential part of the longitudinal power transmission capability of the rope. In this way the whole longitudinal power transmission of the rope can be arranged purely with light fibers. The energy economy of the elevator is therefore good.

Preferably the density of the aforementioned non-metallic fibers is less than 4000 kg/m3, and the strength is over 1500 N/mm2, more preferably so that the density of the aforementioned fibers is less than 4000 kg/m3, and the strength is over 2500 N/mm2, most preferably so that the density of the aforementioned fibers is less than 3000 kg/m3, and the strength is over 3000 N/mm2.

Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments. Each embodiment can also singly and separately from the other embodiments form a separate invention.

### LIST OF FIGURES

In the following, the invention will be described in detail by the aid of some examples of its embodiments with reference to the attached drawings, wherein

FIG. 1 presents by way of reference an elevator according to the invention.

FIGS. 2a-2c present some preferred cross-sections of the overspeed governor rope of an elevator according to the invention.

FIG. 3 diagrammatically presents a magnified detail of a cross-section of the overspeed governor rope of an elevator according to the invention.

FIG. 4 presents a partial view of one preferred overspeed governor arrangement of an elevator according to the invention.

### DETAILED DESCRIPTION OF THE INVENTION

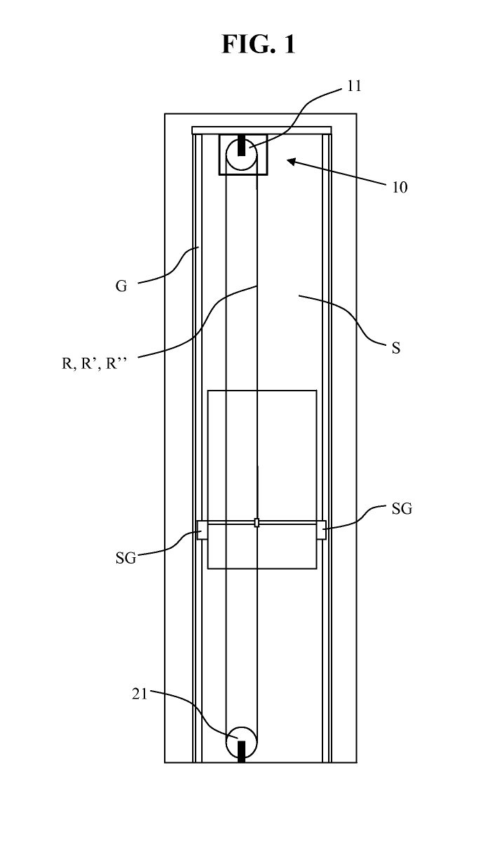

FIG. 1 presents an elevator according to the invention, which comprises an elevator car C and means for moving the elevator car (not presented) along guide rails G, and an overspeed governor arrangement, which comprises an overspeed governor rope R, which moves according to the movement of the elevator car (e.g. along with the movement of the elevator car, preferably moved by the elevator car) and passes around the diverting pulleys (11,21) comprised in the overspeed governor arrangement, bending at the point of each diverting pulley around an axis that is in the width direction of the rope. The overspeed governor rope R,R′,R″ is separate from the means that move the elevator car and is connected to a brake arrangement that is in connection with the elevator car C such that with the overspeed governor rope force can be transmitted to the brake arrangement of an elevator car for shifting the brake SG of the elevator car into a braking position, in which position the brake SG in the embodiment presented grips the guide rail G of the elevator for slowing down or preventing the movement of the elevator car C. The brake SG is preferably arranged to shift into a braking position as a result of relative movement of the rope R,R′,R″ and of the elevator car C (e.g. a wedge safety gear). The width of the overspeed governor rope R,R′,R″ is greater than the thickness in the transverse direction of the rope, and the rope comprises a power transmission part 2 or a plurality of power transmission parts 2, for transmitting force in the longitudinal direction of the rope. The rope comprises a power transmission part (2) or a plurality of power transmission parts (2), for transmitting force in the longitudinal direction of the rope, which power transmission part (2) is at least essentially fully of non-metallic material. Thus the rope can be kept light because its power transmission capability in the longitudinal direction can be formed to be based on non-metallic light fibers. The power transmission part(s) is/are in this case preferably of a material which comprises non-metallic fibers in at least essentially the longitudinal direction of the rope. More particularly, the aforementioned non-metallic fibers are of carbon fiber, glass fiber or Aramid fiber, which are all light fibers. The material of the power transmission part is in this case most preferably formed to be a composite material, which comprises the aforementioned non-metallic fibers as reinforcing fibers in a polymer matrix. Thus the power transmission part 2 is light, rigid in the longitudinal direction and when it is belt-shaped it can, however, be bent with a small bending radius. Especially preferably the fibers are of carbon fiber or glass fiber, the advantageous properties of which fibers can be seen in the table below. They possess good strength properties and rigidity properties and at the same time they still tolerate very high temperatures, which is important in elevators because poor heat tolerance of the hoisting ropes might cause damage or even ignition of the hoisting ropes, which is a safety risk. Good thermal conductivity also assists the onward transfer of heat due to friction, among other things, and thus reduces the accumulation of heat in the parts of the rope. More particularly the properties of carbon fiber are advantageous in elevator use

| | | Glass | | |
|---|---|---|---|---|
| | | fiber | Carbon fiber | Aramid fiber |
| Density | kg/m3 | 2540 | 1820 | 1450 |
| Strength | N/mm2 | 3600 | 4500 | 3620 |
| Rigidity | N/mm2 | 75000 | 200000-600000 | 75000 . . .120000 |
| Softening | deg/C. | 850 | >2000 | 450 . . . 500, |
| temperature | | | | carbonizes |
| Thermal | W/mK | 0.8 | 105 | 0.05 |
| conductivity | | | | |

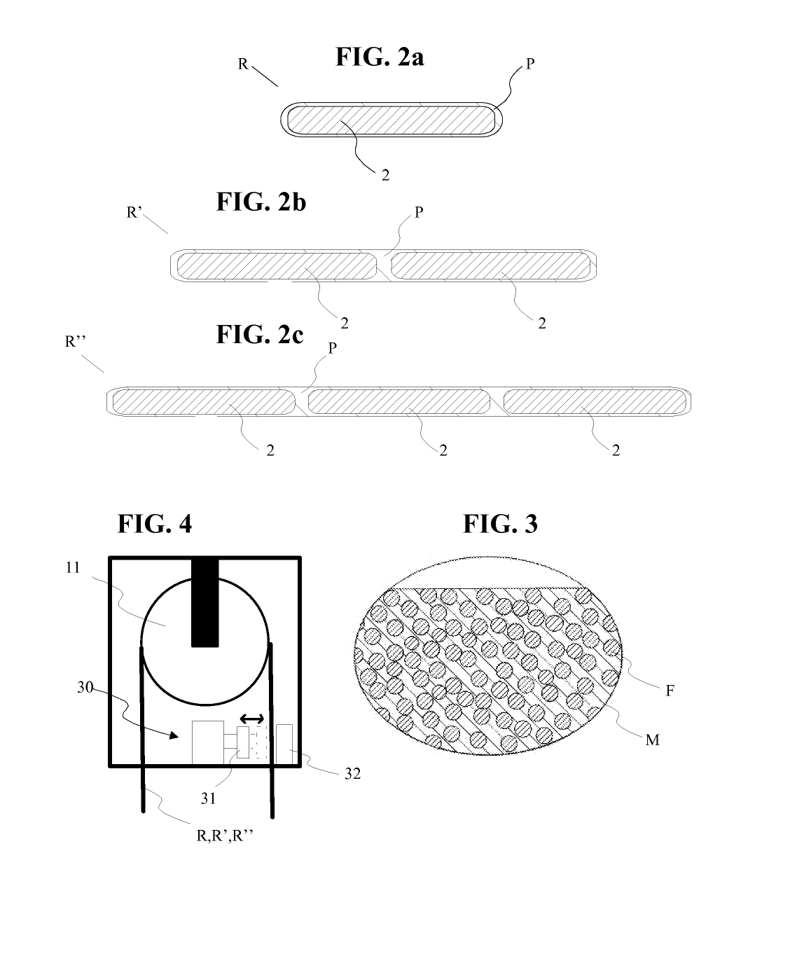

The overspeed governor rope R,R′,R″ of FIG. 1 is preferably according to one presented in FIGS. 2a-2c. As presented in the figures, the aforementioned power transmission part 2 or plurality of power transmission parts 2 together covers majority of the width of the cross-section of the rope for essentially the whole length of the rope. Preferably the power transmission part(s) 2 thus cover(s) 60% or over, more preferably 65% or over, more preferably 70% or over, more preferably 75% or over, most preferably 80% or over, most preferably 85% or over, of the width of the cross-section of the rope. Thus the supporting capacity of the rope with respect to its total lateral dimensions is good, and the rope does not need to be formed to be thick. This can be simply implemented with the aforementioned materials, with which the thinness of the rope is particularly advantageous from the standpoint of, among other things, service life and bending rigidity. When the rope comprises a plurality of power transmission parts 2, the aforementioned plurality of power transmission parts 2 is formed from a plurality of power transmission parts 2 that are parallel in the width direction of the rope and are on at least essentially the same plane. Thus the resistance to bending in their thickness direction is small.

The overspeed governor arrangement of FIG. 1 is preferably according to that presented in FIG. 4. In this case it comprises means 30 for acting on the movement of the overspeed governor rope R,R′,R″, more particularly for slowing down and/or preventing movement, which means 30 are supported on the building. The overspeed governor rope R,R′,R″ is connected to a brake arrangement that is in connection with the elevator car C such that with the overspeed governor rope R,R′,R″ force can be transmitted from the aforementioned means 30 to the brake arrangement for shifting the brake SG into a braking position, e.g. by connecting the rope R,R′,R″ mechanically directly or indirectly to the brake pad comprised in the brake SG. For this purpose the aforementioned power transmission part 2 of the rope must be suited to transmit force in the longitudinal direction of the rope from the point of the means 30 to the brake arrangement via a power transmission part continuing from the point of the means 30 to the brake arrangement on the elevator car.

The means 30 are arranged to exert a force on the overspeed governor rope, in the longitudinal direction of the rope, slowing down the overspeed governor rope or preventing its movement via at least one wide side of the rope, preferably by means of friction and/or shape-locking. In the solution presented in FIG. 4 the means for acting on the movement of the overspeed governor rope R,R′,R″ are separate from the diverting pulley 11, but they could alternatively be in connection with the diverting pulley 11. e.g. such that with the overspeed governor rope force can be transmitted from the aforementioned means (30) to the brake (SG) via the aforementioned diverting pulley 11, e.g. by slowing down and/or preventing the movement of the diverting pulley with the means. In the solution of FIG. 4 the means 30 comprise a brake part 31, which can be shifted into contact with the wide side of the rope R,R′,R″ for slowing down the overspeed governor rope or for preventing its movement. The means 30 comprise the aforementioned brake part 31 and a second brake part 32 that are on opposite sides of the overspeed governor rope, which brake parts form a gripper, which can be shifted into a position compressing the overspeed governor rope for slowing down and/or preventing movement of the overspeed governor rope R,R′,R″. An alternative structure to the structure presented could be such that the brake part 31, which would be pressed against the rope, would be disposed such that at the point of the brake part on the opposite side of the rope is a diverting pulley 11, which would produce counterforce.

The power transmission part 2 or the aforementioned plurality of power transmission parts 2 of the rope R,R′,R″ of the elevator according to the invention is preferably fully of non-metallic material. Thus the rope is light. (The power transmission parts could, however, if necessary be formed to comprise individual metal wires for another purpose than force transmission in the longitudinal direction, for instance in a condition monitoring purpose, but such that their aggregated power transmission capability does not form an essential part of the power transmission capability of the rope.) The rope can comprise one power transmission part of the aforementioned type, or a plurality of them, in which case this plurality of power transmission parts 2 is formed from a plurality of parallel power transmission parts 2. This is illustrated in FIGS. 2b-2c. The rope R,R′,R″ of the elevator according to the invention is belt-shaped. Its width/thickness ratio is preferably at least 2 or more, preferably at least 4, even more preferably at least 5 or more, yet even more preferably at least 6, yet even more preferably at least 7 or more, yet even more preferably at least 8 or more, most preferably of all more than 10. In this way a large cross-sectional area for the rope is achieved, the bending capacity of the thickness direction of which is good around the axis of the width direction also with rigid materials of the power transmission part. Preferably the width of the rope in elevator systems is over 10 mm and the thickness of each aforementioned power transmission part 2 at most 2 mm. The aforementioned power transmission part 2 singly or plurality of power transmission parts 2 together covers over 40% of the surface area of the cross-section of the rope R,R′,R″, preferably 50% or over, even more preferably 60% or over, even more preferably 65% or over. In this way a large cross-sectional area is achieved for the power transmission part/parts of the rope, and an advantageous capability for transferring forces. The rigidity of the rope makes it possible that the tensioning of the rope R,R′,R″ does not require special arrangements, e.g. the tensioning margin does not need to be large and it does not need to be re-adjusted e.g. by transferring the support point of the tensioning weight.

The width of the aforementioned power transmission part 2 is greater than the thickness. In this case preferably such that the width/thickness of the power transmission part 2 is at least 2 or more, preferably at least 3 or more, even more preferably at least 4 or more, yet even more preferably at least 5, most preferably of all more than 5. In this way a large cross-sectional area for the power transmission part/parts is achieved, the bending capacity of the thickness direction of which is good around the axis of the width direction also with rigid materials of the power transmission part. The aforementioned power transmission part 2 or plurality of power transmission parts 2 is surrounded with a coating p in the manner presented in FIGS. 2a-2c, which is preferably of polymer, most preferably of polyurethane. Alternatively one power transmission part 2 could form a rope also on its own, with or without a polymer layer p. The dimensions of the rope are preferably in the range specified by the table below.

| | Power transmission parts | | | |
|---|---|---|---|---|
| | in total/no. | | | |
| | 1 | 2 | 3 | 4 |
| Width of rope/mm | 8-25 | 10-25 | 13-35 | 15-35 |
| Thickness of rope/mm | 0.5-4 | 1.5-4 | 1.5-4 | 1.5-4 |
| Thickness of power | 0.5-2 | 0.5-2 | 0.5-2 | 0.5-2 |
| transmission part/mm | | | | |
| Width of power | 0.6-1 | 0.30-0.47 | 0.2-0.32 | 0.17-0.24 |
| transmission part/ | | | | |
| width of rope | | | | |

For facilitating the formation of the power transmission part and for achieving the constant properties in the longitudinal direction, the structure of the power transmission part 2 continues essentially the same for the whole length of the rope. For the same reasons, the structure of the rope continues preferably essentially the same for the whole length of the rope. In this way also the deceleration of the rope by means of friction/gripping on the rope can be arranged simply. In this case preferably the side surface of the width direction of the rope is flat for enabling power transmission based on friction in the transverse direction and longitudinal direction via the aforementioned side surface. The cross-section can, however, if necessary be arranged to change intermittently, e.g. as toothing.

The aforementioned power transmission part 2 is, in terms of its material, preferably one of the following types. It is a non-metallic composite, which comprises non-metallic reinforcing fibers, preferably carbon fibers, glass fibers or Aramid fibers, more preferably carbon fibers or glass fibers, most preferably carbon fibers, in a polymer matrix M. The part 2 with its fibers is longitudinal to the rope, for which reason the rope retains its structure when bending. Individual fibers are thus oriented in essentially the longitudinal direction of the rope. In this case the fibers are aligned with the force when the rope is pulled. The aforementioned reinforcing fibers are bound into a uniform power transmission part with the aforementioned polymer matrix. Thus the aforementioned power transmission part 2 is one solid elongated rod-like piece. The aforementioned reinforcing fibers are preferably long continuous fibers in the longitudinal direction of the rope, which fibers preferably continue for the distance of the whole length of the rope. Preferably as many fibers as possible, most preferably essentially all the reinforcing fibers of the aforementioned power transmission part are in the longitudinal direction of the rope. The reinforcing fibers are in this case preferably essentially unentwined in relation to each other. Thus the structure of the power transmission part can be made to continue the same as far as possible in terms of its cross-section for the whole length of the rope. The aforementioned reinforcing fibers are distributed in the aforementioned power transmission part as evenly as possible, so that the power transmission part would be as homogeneous as possible in the transverse direction of the rope. The bending direction of the rope is around an axis that is in the width direction of the rope (up or down in the figure). As presented in FIGS. 2a-c, each aforementioned power transmission part 2 is surrounded with a polymer layer 1, which is preferably of elastomer, most preferably of high-friction elastomer such as preferably of polyurethane, which layer forms the surface of the rope.

An advantage of the structure presented is that the matrix surrounding the reinforcing fibers keeps the interpositioning of the reinforcing fibers essentially unchanged. It equalizes with its slight elasticity the distribution of a force exerted on the fibers, reduces fiber-fiber contacts and internal wear of the rope, thus improving the service life of the rope. Possible longitudinal movement between the fibers is elastic shearing exerted on the matrix, but in bending it is mainly a question of the stretching of all the materials of the composite part and not of their movement in relation to each other. The reinforcing fibers are most preferably of carbon fiber, in which case good tensile rigidity and a light structure and good thermal properties, among other things, are achieved. Alternatively glass fiber reinforcing fibers, with which among other things better electrical insulation is obtained, are suited to some applications. In this case also the tensile rigidity of the rope is slightly lower, so that traction sheaves of small diameter can be used. The matrix of the composite, into which matrix the individual fibers are distributed as evenly as possible, is most preferably of epoxy resin, which has good adhesiveness to the reinforcements and which is strong to behave advantageously at least with glass fiber and carbon fiber. Alternatively, e.g. polyester or vinyl ester can be used.

FIG. 3 presents a preferred internal structure for a power transmission part 2. A partial cross-section of the surface structure of the power transmission part (as viewed in the longitudinal direction of the rope) is presented inside the circle in the figure, according to which cross-section the reinforcing fibers of the power transmission parts presented elsewhere in this application are preferably in a polymer matrix. The figure presents how the reinforcing fibers F are essentially evenly distributed in the polymer matrix M, which surrounds fibers and which is fixed to fibers. The polymer matrix M fills the areas between individual reinforcing fibers F and binds essentially all the reinforcing fibers F that are inside the matrix M to each other as a uniform solid substance. In this case abrasive movement between the reinforcing fibers F and abrasive movement between the reinforcing fibers F and the matrix M are essentially prevented. A chemical bond exists between, preferably all, the individual reinforcing fibers F and the matrix M, one advantage of which is, among others, uniformity of the structure. To strengthen the chemical bond, there can be, but not necessarily, a coating (not presented) of the actual fibers between the reinforcing fibers and the polymer matrix M. The polymer matrix M is of the kind described elsewhere in this application and can thus comprise additives for fine-tuning the properties of the matrix as an addition to the base polymer. The polymer matrix M is preferably of a hard non-elastomer. The reinforcing fibers being in the polymer matrix means here that in the invention the individual reinforcing fibers are bound to each other with a polymer matrix e.g. in the manufacturing phase by embedding them together in the molten material of the polymer matrix. In this case the gaps of individual reinforcing fibers bound to each other with the polymer matrix comprise the polymer of the matrix. Thus in the invention preferably a large amount of reinforcing fibers bound to each other in the longitudinal direction of the rope are distributed in the polymer matrix. The reinforcing fibers are preferably distributed essentially evenly in the polymer matrix such that the power transmission part is as homogeneous as possible when viewed in the direction of the cross-section of the rope. In other words, the fiber density in the cross-section of the power transmission part does not therefore vary greatly. The reinforcing fibers together with the matrix form a uniform power transmission part, inside which abrasive relative movement does not occur when the rope is bent. The individual reinforcing fibers of the power transmission part are mainly surrounded with polymer matrix, but fiber-fiber contacts can occur in places because controlling the position of the fibers in relation to each other in their simultaneous impregnation with polymer matrix is difficult, and on the other hand totally perfect elimination of random fiber-fiber contacts is not wholly necessary from the viewpoint of the functioning of the invention. If, however, it is desired to reduce their random occurrence, the individual reinforcing fibers can be pre-coated such that a polymer coating is around them already before the binding of individual reinforcing fibers to each other. In the invention the individual reinforcing fibers of the power transmission part can comprise material of the polymer matrix around them such that the polymer matrix is immediately against the reinforcing fiber but alternatively a thin coating, e.g. a primer arranged on the surface of the reinforcing fiber in the manufacturing phase to improve chemical adhesion to the matrix material, can be in between. Individual reinforcing fibers are distributed evenly in the power transmission part such that the gaps of individual reinforcing fibers comprise the polymer of the matrix. Preferably the majority of the gaps of the individual reinforcing fibers in the power transmission part are filled with the polymer of the matrix. Most preferably essentially all of the gaps of the individual reinforcing fibers in the power transmission part are filled with the polymer of the matrix. The matrix of the power transmission part is most preferably hard in its material properties. A hard matrix helps to support the reinforcing fibers, especially when the rope bends. Tension is exerted on the reinforcing fibers on the side of the outer surface of the bent rope and compression on the carbon fibers, in the longitudinal direction of them, on the side of the inner surface. The compression endeavors to crumple the reinforcing fibers. When a hard material is selected as the polymer matrix, the crumpling of fibers can be prevented because the hard material is able to support the fibers and thus to prevent their crumpling and to equalize the stresses inside the rope. To reduce the bending radius of the rope, among other things, it is thus preferred that the polymer matrix is of a polymer that is hard, preferably something other than an elastomer (an example of an elastomer: rubber) or something else that behaves very elastically or gives way. The most preferred materials are epoxy resin, polyester, phenolic plastic and vinyl ester. The polymer matrix is preferably so hard that its module of elasticity (E) is over 2 GPa, most preferably over 2.5 GPa. In this case the module of elasticity (E) is preferably in the range 2.5-10 GPa, most preferably in the range 2.5-3.5 GPa. Preferably over 50% of the surface area of the cross-section of the power transmission part is of the aforementioned reinforcing fiber, preferably such that 50%-80% is of the aforementioned reinforcing fiber, more preferably such that 55%-70% is of the aforementioned reinforcing fiber, and essentially all the remaining surface area is of polymer matrix. Most preferably such that approx. 60% of the surface area is of reinforcing fiber and approx. 40% is of matrix material (preferably epoxy). In this way a good longitudinal strength of the rope is achieved. When the power transmission part is of a composite comprising non-metallic reinforcing fibers the aforementioned power transmission part is a uniform, elongated, rigid piece. One advantage, among others, is that it returns to its shape from a bent position to be straight.

In this application, the term power transmission part refers to the part that is elongated in the longitudinal direction of the rope, which part is able to bear a significant part of the load in the longitudinal direction of the rope exerted on the rope in question without breaking, which load comprises e.g. the own mass of the rope and the force required for activating the brake. The aforementioned load causes stress on the power transmission part in the longitudinal direction of the rope, which stress is transmitted onwards inside the power transmission part in question in the longitudinal direction of the rope, for essentially a long distance. Thus the power transmission part can, for instance, transmit force from the means 30 to the brake arrangement for shifting the brake SG into a braking position. The power transmission part does not support the elevator car or its load, so it can be dimensioned to be lightweight in structure.

The overspeed governor arrangement could, as an alternative to the solution of FIG. 4, be such that with the overspeed governor rope force can be transmitted to the brake SG via the aforementioned diverting pulley 11, e.g. by slowing down and/or preventing movement of the diverting pulley, around which the overspeed governor rope R,R′,R″ that is in contact with the diverting pulley 11 passes. This could be implemented e.g. conventionally with a centrifugal-type or pendulum-type stopping arrangement of the diverting pulley that is to be fitted in connection with the diverting pulley 11 and that is triggered according to the speed of rotation. Both ends of the overspeed governor rope are in this case preferably fixed in connection with the elevator car in the same way as in the earlier embodiments for forming an essentially endless rope loop.

The aforementioned fibers F are at least essentially longitudinal to the rope, preferably as longitudinal as possible and essentially unentwined with each other. The invention could also, however, be applied with braided fibers. Although the rope of the invention is preferably belt-shaped, its internal structure could also be utilized with other cross-sectional shapes of ropes.

It is obvious to the person skilled in the art that the invention is not limited to the embodiments described above, in which the invention is described using examples, but that many adaptations and different embodiments of the invention are possible within the frameworks of the inventive concept defined by the claims presented below.

1. Elevator, which comprises at least an elevator car and means for moving the elevator car, preferably along guide rails, and an overspeed governor arrangement, which comprises an overspeed governor rope, which moves according to the movement of the elevator car, and which overspeed governor rope is connected to a brake arrangement that is in connection with the elevator car such that with the overspeed governor rope force can be transmitted to the brake arrangement for shifting the brake comprised in the brake arrangement into a braking position, wherein the overspeed governor rope comprises a power transmission part or a plurality of power transmission parts, for transmitting force in the longitudinal direction of the overspeed governor rope, which power transmission part is essentially fully of non-metallic material.

2. Elevator according to claim 1, wherein essentially all the power transmission parts of the rope for transmitting force in the longitudinal direction of the rope are essentially fully of non-metallic material.

3. Elevator according to claim 1, wherein each aforementioned power transmission part is of a material which comprises non-metallic fibers in essentially the longitudinal direction of the rope.

4. Elevator according to claim 1, wherein the overspeed governor rope passes around at least one diverting pulley, comprised in the overspeed governor arrangement, bending at the point of the diverting pulley around an axis that is in the width direction of the rope, and in that the width of the overspeed governor rope is greater than the thickness.

5. Elevator according to claim 1, wherein the aforementioned material is a composite material, which comprises non-metallic fibers as reinforcing fibers in a polymer matrix.

6. Elevator according to claim 1, wherein the aforementioned non-metallic fibers are carbon fibers or glass fibers or Aramid fibers.

7. Elevator according to claim 1, wherein the aforementioned power transmission part or plurality of power transmission parts covers majority, preferably 60% or over, more preferably 65% or over, more preferably 70% or over, more preferably 75% or over, most preferably 80% or over, most preferably 85% or over, of the width of the rope.

8. Elevator according to claim 1, wherein the overspeed governor arrangement comprises means for acting on the movement of the overspeed governor rope, preferably for slowing down and/or preventing movement, which means are preferably supported on the building, and in that an overspeed governor rope is connected to a brake arrangement that is in connection with the elevator car such that with the overspeed governor rope force can be transmitted from the aforementioned means to the brake arrangement for shifting the brake into a braking position.

9. Elevator according to claim 1, wherein the means are arranged to exert a force on the overspeed governor rope, in the longitudinal direction of the rope, slowing down the overspeed governor rope or preventing its movement via at least one wide side of the rope, preferably by means of friction and/or shape-locking.

10. Elevator according to claim 1, wherein the aforementioned plurality of power transmission parts is formed from a plurality of parallel power transmission parts.

11. Elevator according to claim 1, wherein the width/thickness of the rope is at least 2 or more, preferably at least 4, even more preferably at least 5 or more, yet even more preferably at least 6, yet even more preferably at least 7 or more, yet even more preferably at least 8 or more, most preferably of all more than 10.

12. Elevator according to claim 1, wherein the width of the rope is over 10 mm and the thickness of the aforementioned power transmission part at most 2 mm.

13. Elevator according to claim 1, wherein the aforementioned power transmission part or plurality of power transmission parts covers over 40% of the surface area of the cross-section of the rope, preferably 50% or over, even more preferably 60% or over, even more preferably 65% or over.

14. Elevator according to claim 1, wherein the width of the aforementioned power transmission part is greater than the thickness, preferably such that the width/thickness of the aforementioned power transmission part is at least 2 or more, preferably at least 3 or more, even more preferably at least 4 or more, yet even more preferably at least 5, most preferably of all more than 5.
